(19) United States
(12) Patent Application Publication
(10) Pub. No.: US 2026/0300980 A1
(43) Pub. Date: Oct. 1, 2026

(54) METHOD AND DEVICE FOR GRANTING VEHICLE CONTROL AUTHORITY THROUGH BIOMETRIC INFORMATION REGISTRATION

(71) Applicants: Hyundai Motor Company, Seoul (KR); Kia Corporation, Seoul (KR)

(72) Inventor: Yong Seok JEONG, Hwaseong-Si (KR)

(21) Appl. No.: 19/305,244

(22) Filed: Aug. 20, 2025

(30) Foreign Application Priority Data
Mar. 26, 2025 (KR) 10-2025-0038638

(51) Int. Cl. G06Q 20/40; H04L 9/40

(52) U.S. Cl. CPC G06Q 20/40145; H04L 63/0861

(57) ABSTRACT

Methods and systems for registering a user and granting vehicle control authority via a server connected to a vehicle may include: identifying an attempt to register biometric information by a user other than the vehicle owner; permitting a user who holds multiple authentication credentials to register biometric information; and granting vehicle control authority to a user who completes biometric authentication through an in-vehicle biometric authentication module.

### CROSS-REFERENCE TO RELATED APPLICATION

The present application claims priority to a Korean provisional application No.10-2025-0038638, filed on Mar. 26, 2025, the entire contents of which are incorporated herein for all purposes by this reference.

### TECHNICAL FIELD

The present disclosure relates to authenticating users for controlling a vehicle, and more particularly, to a method and/or system for registering a user to use a vehicle based on biometric information of the user and permitting the user to control the vehicle.

### BACKGROUND

The matters described in this Background section are only for the enhancement of understanding of the background of the disclosure, and should not be taken as an acknowledgement that they correspond to prior art already known to those skilled in the art.

Generally, the rise of sharing and rental services for vehicles or ‘moving objects’ (e.g., car, truck, motorcycle, scooter, etc.) is transforming the way people use vehicles. As the number of car rental, car sharing, and vehicle sharing services or applications increases, the same vehicle may be used by various users more frequently than ever. Accordingly, apart from personal use by a vehicle owner, there may be a growing need of maximizing the accessibility and availability of vehicles to users other than the owner.

Especially, in a sharing service where a vehicle is shared by a user other than its owner, convenience and efficiency may be required to enable a user other than the owner to reserve and access the vehicle, and vehicle security is highlighted as an important matter at the same time.

### SUMMARY

The present disclosure is technically directed to providing a method and device for granting vehicle control authority through biometric information registration.

Examples described herein may be directed to providing a method, a device, and/or a system for registering a user other than the owner of a vehicle by connecting the vehicle and a server (e.g., establishing a connection between the vehicle and the server) and for granting vehicle control authority (e.g., authorizing the user to control the vehicle) through biometric authentication (e.g., authentication biometric information of the user).

In addition, in order to solve the technical problems of the present disclosure, Examples described herein may be directed to providing a method , a device, and/or a system for granting a person other than the owner of a vehicle the authority to register biometric information, such as fingerprints, iris information, etc., through a server and granting authority to the user to control the vehicle.

Examples described herein may grant various types of authority, including control authority of a vehicle to an owner of the vehicle and a user through biometric information.

Examples described herein provide a method for registering a user and granting authority through biometric information registration by connecting to a server. The method may include receiving a biometric information registration attempt (e.g., request) of a user other than a vehicle owner, collecting and transmitting biometric data for authentication according to the registration attempt, and activating vehicle control authority that a server grants to the authenticated user. The authority to control the vehicle may be retained only for a preset validity period.

Examples described herein may include a device for granting vehicle control authority through biometric information. The device may include a memory configured to store at least one module (e.g., a set of instructions) and/or an application, and a processor connected to a vehicle management server and configured to register biometric information and share vehicle control authority. The processor may be further configured to receive a biometric information registration attempt (e.g., request) of a user other than a vehicle owner, to collect and transmit biometric data for authentication according to the registration attempt, and to activate vehicle control authority that a server grants to the authenticated user. The authority to control the vehicle may be retained only for a preset validity period.

Examples described herein may include a method comprising: receiving, by a server and from an in-vehicle biometric authenticator of a vehicle, a request to register biometric information of a user other than an owner of the vehicle; receiving, by the server and from the in-vehicle biometric authenticator, first data associated with one or more authenticators associated with the user; registering, by the server and based on the one or more authenticators, the biometric information of the user; and sending, by the server and to the in-vehicle biometric authenticator, second data indicating that: registration of the biometric information of the user is complete; and the user has been granted vehicle control authority.

Examples described herein may include a server comprising: a memory storing at least one instruction; and a processor configured to execute the at least one instruction, wherein the at least one instruction, when executed by the processor, causes the server to: receive, via a wireless communication with a vehicle, a request to register biometric information of a user other than an owner of the vehicle; receive, from an in-vehicle biometric authenticator of a vehicle, first data associated with one or more authenticators associated with the user; register, based on the one or more authenticators, the biometric information of the user; and send, to the in-vehicle biometric authenticators, second data indicating that: registration of the biometric information of the user is complete; and the user has been granted vehicle control authority.

The at least one instruction, when executed by the processor, may cause the server to register the biometric information of the user by determining whether the one or more authenticators satisfy a condition for the registration of the biometric information; and wherein the registered biometric information includes a fingerprint or a face.

The at least one instruction, when executed by the processor, may cause the server to determine whether the one or more authenticators satisfy the condition for registration by determining a presence of: a plurality of indoor frequency operated buttons (FOBs); an authenticated digital key associated with biometric information registration; or a plurality of authenticators comprising an authenticated server account or a near field communication (NFC) card key.

The at least one instruction, when executed by the processor, may cause the server to determine the presence of the plurality of indoor FOBs by determining that the vehicle has detected the presence of the plurality of indoor FOBs inside the vehicle via at least one of a Bluetooth Low Energy (BLE) signal or a ultra-wideband (UWB) signal.

The at least one instruction, when executed by the processor, may cause the server to determine the presence of the authenticated server account by determining the presence of the authenticated server account based on the server account being confirmed to be valid and having an authority in starting up a vehicle or accessing a vehicle, while authenticating the server account.

The at least one instruction, when executed by the processor, may cause the server to determine whether the one or more authenticators satisfy the condition for registration by determining whether the user has at least two of: a first indoor FOB; a second indoor FOB; a digital key; a server account; or a near field communication (NFC) card key. The registration of the biometric information may be valid to authorize the user to control at least one vehicle operation of the vehicle for a preset validity period.

The vehicle control authority granted to the user may comprise: a function for vehicle entry via biometric authentication; an ignition function; or payment authority via a carpay account of the user, and wherein a control authority capable of controlling the vehicle is granted and maintained for a preset validity period based on the granted vehicle control authority.

The vehicle control authority granted to the user may comprise payment authority via a carpay account of the user, and the at least one instruction, when executed by the processor, may cause the server to: connect, based on determining that the biometric information of the user is registered and is associated with the payment authority, the carpay account with the vehicle control authority; and determine whether the biometric information and the carpay account are authenticated; and determine that the payment authority is set to correspond to a sharing period of the vehicle control authority.

Examples described herein may include a method performed by a vehicle, the method comprising: receiving, by an in-vehicle biometric authenticator of the vehicle, first data associated with: a request to register biometric information of a user other than an owner of the vehicle; and one or more authenticators associated with the user; sending, by the in-vehicle biometric authenticator to a server via a wireless communication, the first data; receiving, by the in-vehicle biometric authenticator and from the server, second data indicating that: registration of the biometric information of the user is complete; and the user has been granted vehicle control authority; and activating, based on the second data, a control authority capable of controlling the vehicle for a preset validity period.

### BRIEF DESCRIPTION OF THE DRAWINGS

FIG. 1 shows an exemplary network architecture of a device for granting authority through biometric information registration in connection between a vehicle and a server, according to an example of the present disclosure.

FIG. 2 shows a flowchart showing an exemplary operating mechanism of a device for granting vehicle control authority through biometric information registration based on a server connected with a vehicle, according to an example of the present disclosure.

FIG. 3 shows a flowchart showing an exemplary operating mechanism in registration mode of a device for registering a user through biometric information registration and granting vehicle control authority, according to an example of the present disclosure.

FIG. 4 shows a flowchart showing an exemplary process of executing a payment authority that is granted when biometric information is normally registered, according to an example of the present disclosure.

FIG. 5 shows a flowchart showing an exemplary mechanism of deletion mode for deleting user registration and revoking vehicle control authority, according to an example of the present disclosure.

FIG. 6 shows a flowchart showing an exemplary operating mechanism of an in-vehicle device for registering a user and granting vehicle control authority in connection with a server according to an example of the present disclosure.

FIG. 7 shows an example computing system.

### DETAILED DESCRIPTION OF THE INVENTION

Hereinafter, examples of the present disclosure are described in detail with reference to the accompanying drawings so that those having ordinary skill in the art may easily implement the present disclosure. However, examples of the present disclosure may be implemented in various different ways, and thus the present disclosure is not limited to the examples described therein.

In describing examples of the present disclosure, well-known functions or constructions have not been described in detail since a detailed description thereof may have unnecessarily obscured the gist of the present disclosure. The same reference numerals denote the same constituent elements in the drawings, and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other to describe each feature clearly, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be construed as being limited to the examples set forth herein. Rather, the examples described herein are provided to make this disclosure more complete and to fully convey the scope of the present disclosure to those having ordinary skill in the art to which the present disclosure pertains. For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

Throughout the present disclosure, references to components, units, or modules generally refer to items that logically can be grouped together to perform a function or group of related functions. Like reference numerals are generally intended to refer to the same or similar components. Components, units, and/or modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry, for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives, and the like, which may provide non-transitory storage at any time for software programming.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring to them as “first chip,” and “second chip,” respectively.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units”, or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices, such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system, but may also be distributed across a network. Examples of such media include magnetic media such as a hard disk, a floppy disk, or a magnetic tape, optical recording media such as a compact disc ROM (CD-ROM) or a digital video disc (DVD), magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

The expression “based on,” as used herein, is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic-purpose processor capable of performing the specific operation by executing software, or to a special-purpose computer structured through programming to perform the specific operation.

The disclosed method enables a server to register the biometric data (e.g., fingerprint, facial recognition, iris scan, retina scan, palm print, hand geometry, voice recognition, etc.) of a person who is not the owner of a vehicle and to permit the person to use the vehicle based on authentication of the provided biometric data. The process may begin when an application in the vehicle sends a registration request and related biometric data of a user to the server. This data further includes one or more forms of user authentication, such as key fobs, a digital key, a user account, or an NFC card. The server evaluates whether these forms of user authentication meet predefined conditions for registration. For example, the predetermined condition may be that at least two forms of user authentication are provided to the server (e.g., two key fobs, or a key fob and a user account). If verified, the server may register the biometric information and return a confirmation to the vehicle, indicating that registration is complete and the user is authorized to control the vehicle.

The user may be permitted to use the vehicle in the future based on the authentication of biometric data from the user. Control authority granted to the user may include vehicle entry using biometric verification, engine start capability, payment functionality through a linked “carpay” account, etc. The system may require multiple forms of authentication for added security and can limit access to a specific time period. If payment access is enabled, the server authenticates the link between the user’s biometric data and their carpay account and ensures that the payment rights match the user’s authorized access period. The system may also revoke access automatically once the preset validity period ends. The same logic and functionality may be implemented within a server configured to execute the described steps, ensuring secure and conditional access to vehicle functions.

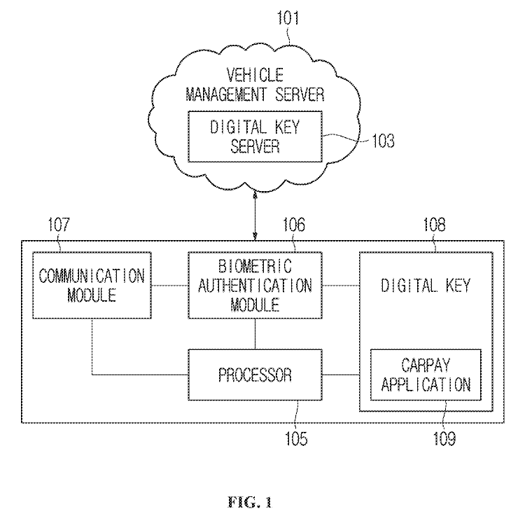

Hereinafter, referring to FIG. 1, a network architecture comprising a device for granting vehicle control authority through biometric information registration will be described.

The one or more features described herein (e.g., the biometric information registration of a user other than an owner of a vehicle, the one or more authentication features associated with the biometric information registration, etc.) may be associated with granting vehicle control authority for one or more operations of autonomous driving of a vehicle.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: a biometric information registration of a user other than an owner of a vehicle, one or more authentication features associated with the biometric information registration associated with granting vehicle control authority for one or more operations of autonomous driving of a vehicle, an autonomous driving classification, a selection of an autonomous driving level for a vehicle, etc.). Based on one or more features (e.g., feature of a biometric information registration of a user other than an owner of a vehicle, one or more authentication features associated with the biometric information registration associated with granting vehicle control authority for one or more operations of autonomous driving of a vehicle, etc.) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., a biometric information registration of a user other than an owner of a vehicle, one or more authentication features associated with the biometric information registration associated with granting vehicle control authority for one or more operations of autonomous driving of a vehicle, etc.) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of managing a battery of a vehicle) described herein.

Minimum risk maneuver (MRM) operation(s) may also be controlled, for example, based on one or more features (e.g., feature of a biometric information registration of a user other than an owner of a vehicle, one or more authentication features associated with the biometric information registration associated with granting vehicle control authority for one or more operations of autonomous driving of a vehicle, etc.) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of a biometric information registration of a user other than an owner of a vehicle, one or more authentication features associated with the biometric information registration associated with granting vehicle control authority for one or more operations of autonomous driving of a vehicle, etc.) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of a biometric information registration of a user other than an owner of a vehicle, one or more authentication features associated with the biometric information registration associated with granting vehicle control authority for one or more operations of autonomous driving of a vehicle, etc.) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of a biometric information registration of a user other than an owner of a vehicle, one or more authentication features associated with the biometric information registration associated with granting vehicle control authority for one or more operations of autonomous driving of a vehicle, etc.) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

FIG. 1 is a view illustrating a network architecture of a device for granting authority through biometric information registration in connection between a vehicle and a server according to an example of the present disclosure.

As illustrated in FIG. 1, a network architecture of a device for granting vehicle control authority through biometric information registration may be described by a system block diagram showing interaction between a vehicle management server and an in-vehicle device, thereby describing how respective components work along with their interaction. In the present disclosure, the “system” may include at least one device among a computing device, a network device, a controller, a vehicle device, a server device, and/or a cloud device, but is not limited thereto. For example, the system may include (or be configured with) one or more server devices. As another example, the system may include (or be configured with) one or more cloud devices. As another example, the system may operate with a server device and a cloud device.

First, a vehicle management server 101 (e.g., in a cloud) may be in charge of the connection between a vehicle and the vehicle management server 101, and the vehicle management server 101 may include a digital key server 103. The vehicle management server 101 may be a central control server capable of performing such functions as digital key management, user authentication, granting of vehicle control authority, and/or payment processing. The vehicle management server 101 may enhance security and convenience by managing an intra-vehicle network and an external network in an integrated way. The external network may include a smartphone application, a payment system, an IoT device, and the like. For example, a vehicle management server may be a centralized control server (CCS) developed, and the CCS may be a central management server that may perform digital key management and user authentication, grant vehicle control authority, and/or enable connection to a payment service in connection with a vehicle. Hereinafter, for convenience, the vehicle management server 101 may be described as an example CCS server.

A user other than the owner of a vehicle may use the above-described various functions only when the user generates a server account through the vehicle management server 101. For example, a server account may be a CCS account that is generated by a vehicle management server and may be granted to a vehicle owner and a user other than the owner. Hereinafter, for convenience, a server account will be described as an example CCS account. A CCS account may be a personal account connecting a vehicle and the vehicle management server 101 and may store a digital key, vehicle control authority, and/or payment information, and perform authentication of the vehicle and a user by interacting with the vehicle management server 101. That is, a CCS account may store a user’s authentication information and digital key. The user’s authentication information may include biometric information like fingerprints and facial recognition, a password, a security code, and/or other authentication data (e.g., iris scan, retina scan, palm print, hand geometry, voice recognition, etc.).

Specifically, in the case of digital key management and authentication, a digital key connected with a CCS account may be generated, stored, or distributed, and an owner of a vehicle may register and share the digital key through the CCS account. Herein, security may be strengthened in connection with biometric authentication of fingerprint or facial recognition, or password authentication. In addition, for vehicle access and control authority management, access to a vehicle may be set to be permissible only to an authenticated user with a digital key of a CCS account that has been authenticated. As a CCS is capable of managing such functions as unlocking, ignition, and remote control of a vehicle in a centralized way, access authority for a shared vehicle may be controlled through transmission of a digital key between CCS accounts. As for in-vehicle payment authority, a CCS server may grant payment authority in connection with a carpay application 109 in a vehicle and perform payment. On-site payment may be possible in a vehicle by using a payment form registered in a CCS account. Security may be strengthened by further requiring biometric information related to payment authority during the payment process.

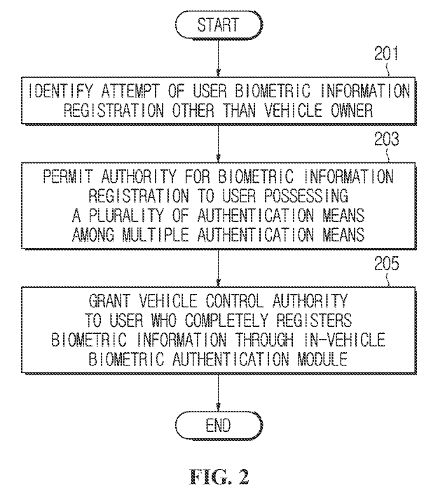

In a communication process between the CCS server 101 and a vehicle, when a user accesses the vehicle, the CCS server 101 may request authentication, generate a digital key from the digital key server 103 after the authentication is completed, and connect the user and the vehicle. A specific process of registering a user and granting vehicle control authority in a server connected with a vehicle will be described in detail in FIG. 2 below.

The digital key server 103 included in the CCS server 101 may perform functions of generating, managing, and authenticating a digital key within the CCS server. The digital key server 103 may be connected with a vehicle, a user’s smart device, and a CCS account and provide functions of vehicle access authentication and control, digital key sharing and authority setting, and in-vehicle payment system connection, apart from digital key generation and distribution. A digital key generated by a digital key server is an electronic key that may perform vehicle access and control through a smart device instead of a physical vehicle key. The smart device may include a smartphone, a smartwatch, a card key, and a cloud system. A digital key may be stored in an application and communicate with a vehicle through near field communication (NFC), ultra-wideband (UWB), or cloud authentication.

Next, a vehicle system interacting with a CCS may include a processor, a communication module, a biometric authentication module, a memory, and a carpay application. First, an in-vehicle processor 105 may be connected to every main system of a vehicle, may communicate with the vehicle management server 101, and may perform authentication and control functions. It may process user authentication and vehicle control signals in connection with the vehicle management server 101 and the digital key server 103. In addition, in connection with a biometric authentication module 106, it may verify a user’s biometric authentication and transmit and receive data with a smart device and a remote server through a communication module 107. In case an in-vehicle carpay application 109 is run, the processor may support an in-vehicle payment system by processing payment information.

The biometric authentication module 106 may perform a function of verifying whether a user has vehicle control authority. It may perform authentication by sensing various biometric information such as a user’s fingerprints, facial features, and iris patterns. It may process a biometric authentication result in connection with the in-vehicle processor 105 and the vehicle management server 101, and if the authentication is successful, permit vehicle control by activating a digital key generated by the digital key server 103. For example, when a user of a vehicle opens a door of the vehicle or starts up the vehicle, authentication may be performed, and the vehicle processor 105 may compare previously registered information with data received from the biometric authentication module 106 to perform verification. If both pieces of data match each other, an authentication request may be transmitted to the vehicle management server 101, and when authentication is completed, the vehicle may be controlled. On the other hand, if the pieces of data do not match each other, the function may be inaccessible, and further authentication may be required.

The communication module 107 may connect a vehicle to an external system. That is, it may support a vehicle such that the vehicle may be connected to a CCS, a digital key server, and an external network. The communication module 107 may perform digital key authentication by using a technology like Bluetooth Low Energy (BLE), NFC, and UWB, and keep a real-time connection with a CCS through a 5G or LTE-based vehicle communication function. In addition, it may enable connection to various devices by supporting Wi-Fi and IoT functions within a vehicle. Specifically, when a user accesses a vehicle, the communication module 107 may transmit a digital key authentication request through BLE, UWB, or NFC and communicate with a CCS to authenticate the user and identify vehicle control authority. For example, when receiving a remote control request like a vehicle ignition request from an application on a smartphone, the communication module 107 may forward the request to a CCS and transmit a result to a vehicle processor.

A memory 108 may be a storage device in a broad sense, which stores authentication data, a digital key, and a vehicle setting within a vehicle. By storing digital keys, the memory 108 may store a list of users, who may access the vehicle and authentication data. In addition, the memory 108 may encrypt and store biometric information such as a user’s fingerprint and facial recognition data and save user settings to provide a personalized environment. Specifically, when a user registers a digital key or a CCS account, encrypted authentication data may be stored in a memory. When biometric authentication is performed, previously stored data may be provided to enable comparative checking of whether biometric information matches the previously stored data. In addition, a digital key or vehicle setting information updated in a CCS may be received and stored in memory. If necessary, synchronization with a CCS server may be performed to retain the latest information. The memory 108 may include the carpay application 109.

The carpay application 109 may be an application that supports in-vehicle payment. For example, the carpay application 109 may transmit and receive payment requests to and from terminals at a gas station, a parking lot, and a tollgate through BLE, NFC, UWB, or cloud. The carpay application 109 may store a user’s payment information in connection with a CCS account and perform an in-vehicle automatic payment function in connection with the vehicle processor 105. By being connected to the CCS server 101, the carpay application 109 may request payment information processing and approval in real time. Specifically, when payment authority is authenticated by in-vehicle digital key and biometric authentication, a payment request may be transmitted. A CCS server may authenticate a user’s registered payment information and then approve payment, and when payment is completed, the carpay application 109 may provide the user with payment details.

FIG. 2 is a flowchart showing an exemplary operating mechanism of a device for granting vehicle control authority through biometric information registration based on a server connected with a vehicle, according to an example of the present disclosure. For convenience, FIG. 2 is described by way of an example in which a processor circuit performs the steps. One, some, or all steps of the example method of FIG. 2, or portions thereof, may be performed by one or more other circuits. One or more steps of the example method of FIG. 2 may be omitted, performed in other orders, and/or otherwise modified, and/or one or more additional steps may be added.

Referring to FIG. 2, a method for granting vehicle control authority through biometric information registration according to the present disclosure may include identifying or receiving an attempt of user biometric information registration other than a vehicle owner (201), granting authority for the biometric information registration to a user possessing a plurality of authenticators among multiple authenticators (203), and granting vehicle control authority to a user who completely registers biometric information through an in-vehicle biometric authentication module (205).

First, according to step S201, the identifying of the attempt of user biometric information registration other than the vehicle owner, or receiving a request for registration of user biometric information, may be performed when the vehicle owner or a service provider shares vehicle control authority with a user of a vehicle. When sharing the vehicle control authority with the user, the vehicle owner or service provider may share a CCS account or a digital key, including information on the biometric information registration authority.

When it is confirmed that a user other than the vehicle owner attempts to register biometric information at the initiation of a registration mode, it is possible to identify whether the user attempting to register the biometric information has received authority to share a CCS account or a digital key. Generally, a vehicle owner may grant biometric registration authority to another user through a CCS account or a digital key. Herein, because it should be confirmed that the user has been given the authority through the CCS account or the digital key, a vehicle system may access the CCS to confirm that the user is a registered user, verifying the authority in real time.

Next, according to step S203, the permitting of the authority for the biometric information registration to the user possessing the plurality of authenticators among multiple authenticators may check whether the user holds at least two authenticators and grant the authority for the biometric information registration only when the user holds an additional authenticators. Herein, the authenticators may include a frequency operated button (FOB), a digital key, an NFC card key, or a CCS account. For example, if the user holds both an FOB and a digital key, the authority for the biometric information registration may be granted to the user. A key fob may comprise a small electronic device that may be used to access and/or control a vehicle without a physical key.

When it is confirmed that there are two or more authenticators, a CCS may grant authority for biometric information registration to a corresponding user. An external user, who is not a vehicle owner, may be permitted to access and register to a biometric authentication system of a vehicle.

When a user sharing vehicle control authority through step S203 makes a first attempt to enter or start a vehicle through authentication, it is possible to check whether a shared CCS account or digital key includes authority for biometric information registration. That is, a user who has been granted registration authority may access a vehicle and confirm biometric registration authority through digital key authentication or CCS account authentication, and then check on a vehicle display unit whether registration is possible. However, the vehicle may have a setting about whether to display an alert. For example, even when no alert is displayed, the vehicle may be set to permit entry into registration mode. The function to enable entry into registration mode with no alert being displayed may enable a user to proceed with biometric information registration when there is no warning or notification.

Next, according to step S205, the granting of the vehicle control authority to the user who has completed registration of their biometric information through the in-vehicle biometric authentication module grants the vehicle control authority after biometric information registration is completed, and thus enables the user to use a function of the vehicle. A user who has been granted authority for biometric information registration may register their biometric information through an in-vehicle biometric authentication module. A biometric authentication module of a vehicle may collect a user’s information and register the information in a vehicle system. For example, through a biometric authentication module, a user’s fingerprint may be registered, or facial information may be registered.

When registered biometric information is registered in the vehicle, the information may be transmitted to a CCS and stored therein. Then, in connection with a CCS account, the biometric information may be used to perform authentication in a processor of the vehicle. After biometric authentication registration is completed, the vehicle may grant control authority of the vehicle to the user. Thus, the user may access the vehicle and use a function of the vehicle. For example, when the user completes fingerprint authentication, the vehicle may be unlocked and start running, and a control function may be executed. That is, after the vehicle confirms that the user’s biometric information is normally registered and is connected to a CCS, the vehicle may grant control authority to the user and activate the control function of the vehicle.

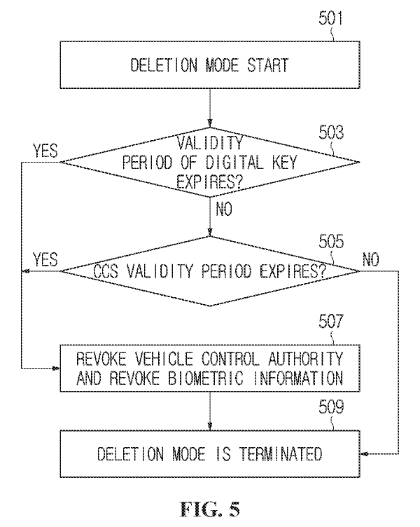

In addition, the vehicle control authority may be set to be valid only for a preset specific period. The owner of the vehicle may set a validity period for the vehicle control authority when sharing the authority with another user. The validity period may be set on a time or date basis or for a specific period. A user, who is permitted to share vehicle control authority, may access the vehicle during a validity period and have the authority to control the vehicle. When validity expires, the vehicle control authority may delete biometric information through deletion mode, and the authority may be revoked. Deletion mode will be described in detail in FIG. 5 below.

If the vehicle owner wants to extend the validity period, the validity period may be reset or modified in a CCS or a digital key server of the vehicle. For example, the vehicle owner may extend a validity period, which is set to expire in one week, by one month. Setting a validity period may enhance security. A vehicle owner may grant vehicle control authority to a first user only for a predetermined period, and after the period passes, revoke the authority and prevent unnecessary abuse of vehicle authority. In addition, as a vehicle owner needs to revoke authority anytime in case of an emergency, a system may be designed to terminate authority when the validity period expires.

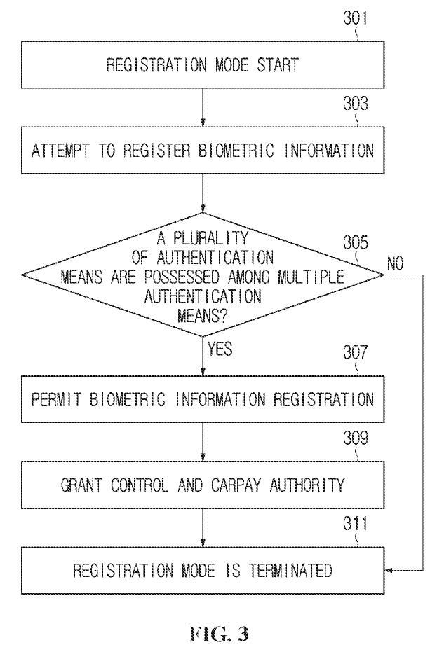

FIG. 3 is a flowchart showing an operating mechanism in registration mode of a device for registering a user through biometric information registration and granting vehicle control authority according to an example of the present disclosure. For convenience, FIG. 3 is described by way of an example in which a processor circuit performs the steps. One, some, or all steps of the example method of FIG. 3, or portions thereof, may be performed by one or more other circuits. One or more steps of the example method of FIG. 3 may be omitted, performed in other orders, and/or otherwise modified, and/or one or more additional steps may be added.

Referring to FIG. 3, a method for granting vehicle control authority through biometric information registration may permit entry into registration mode of a biometric authentication module in a vehicle if a condition set by a CCS is satisfied.

Specifically, when the registration mode begins (301), the CCS may identify previously registered user information and examine whether it is possible to add a new user. Accordingly, if registration is possible, the user may attempt to register biometric information to the vehicle (303) or send a request to register biometric information (303). At step S303 above, the user attempting to register for the vehicle may be requested to select a biometric authenticators that can be registered. Herein, the biometric authenticators that can be registered may include a fingerprint, a face, and/or an iris. Biometric information thus input may be encrypted and temporarily stored in a process in the vehicle, and the processor may check whether the biometric information can be normally processed, through communication with the CCS. When the biometric information is completely input, step S305 may be performed to check whether a plurality of authenticators are possessed among multiple authenticators. However, if input fails, a retry may be requested.

Next, the CCS may check whether a plurality of authenticators are possessed among multiple authenticators (305). The CCS may set a biometric information registration condition and permit the vehicle to enter biometric information registration mode based on the condition. The vehicle may identify the registration condition and enter the registration mode if at least one condition is satisfied.

The biometric information registration condition set by the CCS may include whether there are multiple indoor FOBs, whether there is an authenticated digital key or CCS account, and whether there are multiple authenticators.

First, checking whether there are multiple indoor FOBs may comprise checking whether there are several FOBs inside the vehicle, and when the vehicle enters the biometric information registration mode, the number of FOBs may be retrieved and saved in the vehicle. The vehicle may retrieve an FOB inside it through a low frequency (LF) signal and thus identify and store the number of FOBs. Herein, the number of FOBs may be two. That is, when the number of FOBs is two, based on the information, the vehicle may determine whether or not to enter the registration mode. If there are two FOBs, the user may apply one of multiple authentication methods when sharing the vehicle.

Whether there is a digital key or a CCS account authenticated as an authority capable of registering biometric information may be identified when the vehicle is started and at the time of entry and exit. When the biometric information is to be registered, it is possible to check whether the authority is authenticated through a digital key or a CCS account. For example, when the vehicle is started, it is possible to check whether an authenticated digital key has the authority to start up the vehicle. At the time of entry into or exit from the vehicle, it is possible to check whether a digital key or a CCS account accessing the vehicle has the user’s authority. That is, based on a digital key or a CCS account, the vehicle may check whether a user has been authenticated and identify the authority. The vehicle may identify authority based on authentication information connected with a digital key or a CCS account and permit entry into biometric information registration mode when a corresponding condition is satisfied.

Checking whether there are a plurality of authenticators may be a process of checking whether a user holds two or more authenticators. This process may be performed at the time of entry into the registration mode, and the authentication modes may include an FOB, a digital key, an NFC card key, and a CCS account. The vehicle may search for an FOB by using an LF signal and search for a digital key through ultra-wideband (UWB) and an NFC. Based on the above-pieces of information, the vehicle may determine whether a user holds multiple authenticators, and only if so, may permit the user to enter into the biometric information registration mode. In addition, an in-vehicle processor may examine whether the currently input biometric information matches previously input information.

That is, according to step S305 above, if a user is identified as holding a plurality of authenticators among multiple authenticators, a function may be provided to enable the user to select a plurality of authenticators and register biometric information (307). In addition, authority for biometric information registration is checked in a digital key, and only if the number of available registrations is valid, entry into biometric information registration mode may be permitted. A user may manage the biometric information registration authority for a digital key and the number of registrations in a CCS account. For example, a CCS account may grant biometric information registration authority using a digital key to a specific user and set the number of available registrations in advance. When a user approaches the vehicle and attempts to register biometric information, the vehicle may check a preset number of registrations and authority in a CCS. If the number of available registrations is valid and authority is granted, the vehicle may permit entry into the biometric information registration mode. However, according to step S305 above, if it is determined that a plurality of authenticators is not held, the biometric information registration mode may be terminated (311).

If biometric information registration is permitted at step S307 above, the CCS may set control authority and carpay authority for a user (309). The vehicle may provide the user with a function according to the authority. Control authority may mean authority to drive or operate the vehicle, and carpay authority may mean authority to proceed with payment in the vehicle. If a user sharing the vehicle holds several authenticators, each authority may be managed through a CCS account, and control and payment authority suitable for each authority may be granted to the user. After identifying the authority granted in a CCS account, the vehicle may activate an adequate function for the authority for a user. For example, a user with granted control authority can drive the vehicle, and a user with granted carpay authority can perform in-vehicle payment.

Specifically, the digital key authority of the vehicle or a CCS account may be allocated to a user who has registered biometric information. In communication between a CCS and the in-vehicle processor, vehicle control authority and payment authority may be added to a user’s account. For example, vehicle control authority may include a door unlock function, an ignition On/Off function, and a remote control. The carpay function may link payment information (e.g., credit card, simple payment) to a user in connection with a CCS account. It may configure a simple in-vehicle payment using registered biometric information. When payment authority is activated through a carpay application, automatic payment through biometric authentication may become possible. If every control authority and payment authority is normally granted, a registration mode termination step may be performed (311).

The registration mode termination step (311) may reflect a normal completion result of every process in the system and terminate the registration process. A vehicle processor and a CCS may store a user’s authentication information and authority grant information, and terminate the registration mode procedure. A registration complete message may be displayed on an in-vehicle display or a user’s mobile application. In addition, it is possible to actually access a vehicle and perform a control test by registered biometric information. After registration, a log record may be examined to see whether authentication is normally operated in a vehicle system and a CCS. For example, a user may perform biometric authentication to check whether a vehicle door is normally opened or perform a payment test to see whether an in-vehicle carpay function is normally activated.

That is, referring to FIG. 3, a biometric information registration process is a key process that sets up a vehicle control and payment system through biometric information while a CCS and a vehicle are connected with each other. A user may register several authentication methods to strengthen the security of an authentication process, and registered biometric information may be encrypted and managed in a CCS and a processor of a vehicle. When registration is completed, vehicle door unlock, ignition, remote control, and carpay payment may become possible, and thus convenience may be provided.

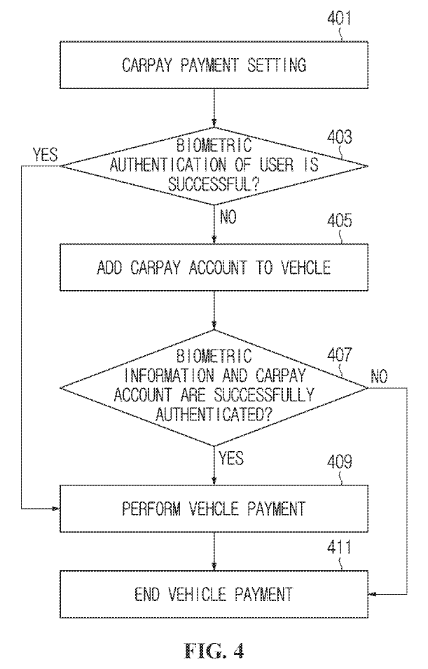

FIG. 4 is a flowchart showing a process of executing a payment authority that is granted when biometric information is normally registered according to an example of the present disclosure. For convenience, FIG. 4 is described by way of an example in which a processor circuit performs the steps. One, some, or all steps of the example method of FIG. 4, or portions thereof, may be performed by one or more other circuits. One or more steps of the example method of FIG. 4 may be omitted, performed in other orders, and/or otherwise modified, and/or one or more additional steps may be added.

Referring to FIG. 4, when payment authority is granted to a user through biometric information registration according to the present disclosure, a payment service may be used through an account of a carpay application connected with a CCS account generated in a CCS.

First, payment through carpay may be possible by registering a vehicle connected with the CCS account in the carpay application through a carpay payment setting 401. In a process where a vehicle owner or a user other than the vehicle owner sets a carpay payment function, the carpay application may be activated mainly by connecting a vehicle with a CCS account, and authority may be set to enable payment to be available in the vehicle. The vehicle owner or a user holding a digital key or a CCS account may add a payment function to the vehicle through a carpay payment setting. An integrated setting with the carpay application may be established through connection between the vehicle and a CCS account, and thus, payment authority may be granted to a carpay account connected to the CCS account. A user, who is a sharer, may also be granted vehicle payment authority through biometric authentication, and this authority may be set in connection with a digital key or a CCS account.

Next, the vehicle may perceive biometric information and connect it to a CCS to determine whether biometric authentication is successful (403). When the vehicle owner or a user accesses or enters the vehicle, authority for use may be identified through biometric authentication. For example, when a user tries to ride the vehicle, the user may input biometric information, and the vehicle may identify it. An input of biometric information may include a fingerprint or a facial feature. If biometric authentication is successful, the vehicle may permit the user to perform payment in the vehicle (309) immediately. That is, at step S303 above, whether biometric information is registered and whether it is valid may be checked.

However, if biometric authentication fails, a carpay account may be added to the vehicle (305), and whether biometric information and the carpay account are authenticated (307) may be determined to perform payment in the vehicle (309). Generally, only the owner of a vehicle can activate and use a carpay payment function, but a function may be additionally provided so that a user other than the owner can use vehicle payment through a carpay account. That is, a sharer of a digital key or a CCS account other than a vehicle owner may activate a carpay payment function.

Specifically, when a carpay account is added to the vehicle according to step S307 above, the vehicle may activate the carpay payment function for the user after biometric authentication so that the user can use in-vehicle payment. When a digital key sharer or a CCS account sharer registers biometric information in the vehicle, the vehicle may upload the information to a CCS. The uploaded biometric information may be linked to the sharer’s carpay account, and a payment function may be activated in the vehicle. Accordingly, vehicle payment authority may be added to the carpay account connected with the CCS. The vehicle may register biometric information, upload the information to a CCS, and add the information to a carpay account.

After a user rides the vehicle and obtains permission for entry and ignition of the vehicle through biometric authentication, when the user wants to use a carpay payment function, it may be determined whether biometric information and a carpay account have been successfully authenticated (307). Through biometric authentication, the vehicle may permit the user to enter and start it, and an additional authentication procedure may be needed to use payment through the carpay account. It is possible to check whether biometric information registered in the vehicle is connected with the carpay account that is added to the vehicle at step S305 above. The CCS account and the carpay account may have already been connected with each other, but the biometric information and the carpay account need to be normally authenticated when a payment function is used in the vehicle. If both the biometric information and the carpay account are successfully authenticated, payment authority may be activated through an in-vehicle payment system. Whether authentication is successful may be identified through a connection between the vehicle and a carpay application. That is, whether authentication is successful may be determined based on whether a user’s biometric information is normally registered in a vehicle and whether payment authority of the vehicle is granted to a carpay account. If biometric information and a carpay account are successfully authenticated, a user other than the owner of a vehicle may also use a payment function in the vehicle. However, if authentication fails, vehicle payment may be terminated (311).

After the authentication process according to step S307 above, a user may actually execute an in-vehicle payment function (309). For example, a user of a vehicle may pay for fuel, parking, and charging through an in-vehicle carpay system. The user may select one of the services provided by the in-vehicle payment system and proceed with payment through biometric authentication. The vehicle may proceed with the payment through a payment system connected with a carpay account. Herein, a carpay account connected with a CCS account may be used for payment. The vehicle may execute the payment system in connection with the carpay application, and the user may complete payment through biometric authentication.

When vehicle payment is completed or the authentication of step S307 fails, the vehicle payment process may be terminated (311). If the payment processing process is terminated and payment is completed, a payment detail may be delivered to the user. When payment processing is completed, the vehicle may record the payment details in connection with the carpay application and the CCS account. The user may check the payment details and retrieve them in the carpay application. The payment process may be terminated in the vehicle, and the payment may be terminated in a payment complete state. After payment is terminated, the vehicle and the carpay application may update the payment details and provide a user with a payment complete notification.

In addition, a grant period of control authority according to biometric information registration may continue for a validity period that is preset by the owner of a vehicle. A validity period of payment authority by a carpay application may also be set to be the same as the validity period of the control authority. That is, if the validity period with granted control authority for a vehicle expires, the carpay payment authority may be terminated together. For example, if the control authority has a validity period of one year, the carpay payment authority may also be valid for one year, and both authorities may be terminated in one year.

When the control authority and the payment authority have the same validity period, security may be strengthened because a user can use a payment function only while maintaining access authority to the vehicle. For example, when the vehicle is shared, if the control authority is terminated, the carpay payment authority connected with it may be terminated together so that the payment function may be revoked to reduce security risk. In addition, as compared to separately managing control authority and payment authority, a user of the vehicle may uniformly manage authority by setting a single validity period. As there is a coincidence of termination time, the authority update or termination processing becomes simpler, which may make management efficient. At a time when vehicle control authority is granted, carpay payment authority may be granted, and thus both authorities may be managed based on the same criterion, and as the same termination time is set, management may be consistent in a system.

FIG. 5 is a flowchart showing a mechanism of deletion mode for deleting user registration and revoking vehicle control authority according to an example of the present disclosure. For convenience, FIG. 5 is described by way of an example in which a processor circuit performs the steps. One, some, or all steps of the example method of FIG. 5, or portions thereof, may be performed by one or more other circuits. One or more steps of the example method of FIG. 5 may be omitted, performed in other orders, and/or otherwise modified, and/or one or more additional steps may be added.

Referring to FIG. 5, a method for revoking vehicle granted control authority according to the present disclosure may revoke the control authority, when a validity period of a digital key or a CCS expires based on the connection between vehicle sharing and biometric information, and delete the biometric information.

First, a deletion mode may start to initialize authority, including the vehicle control authority and biometric information (501). When the deletion mode starts (501), a vehicle may shift to the deletion mode, and a task of revoking authority and deleting authentication information may start. The deletion mode may check validity periods of a CCS account, a digital key, and biometric information, which are set in the vehicle, and then start a task of deleting and initializing the corresponding authority and authentication information. A CCS may manage step S501, and when a deletion command is delivered to the vehicle, a deletion procedure may start in a corresponding vehicle system.

Next, whether the validity period of the digital key has expired may be checked (503). A preset validity period of the digital key may be checked to see whether expiry has been reached. In this case, if the validity period of the digital key has expired, the authority granted to the corresponding digital key may be revoked, and a procedure of revoking and initializing biometric information may be performed. However, if the validity period of the digital key has not expired, the digital key authority may still be valid, and thus, step S505 may be performed to check the validity period of the CCS account.

As a CCS account generated by a CCS is a key element that controls the authority of a vehicle, checking whether the CCS validity period has expired (507) may help determine whether the validity period has expired. If the CCS validity period has expired, the control authority and biometric information, which are connected with the CCS account, may be revoked (507). Herein, the vehicle system may delete the biometric information and initialize it in the vehicle. On the other hand, if the CCS validity period has not expired, the deletion mode may be terminated (509). That is, because authority revocation and information deletion are not necessary, step S509 may be performed to terminate the deletion mode.

If the validity period expires at step S503 or S505, the control authority may be revoked, and the biometric information may be revoked (507). In this case, if the authority granted to a digital key or a CCS account is terminated or the biometric information registered in the vehicle is not valid anymore, the vehicle may delete all registered biometric information. All biometric data, such as fingerprints and faces registered in a biometric authentication module, may be deleted, and a relevant profile may be initialized. The vehicle may revoke every authority granted to a digital key and a CCS account, and this may terminate every authority granted to a user, including entry into the vehicle, ignition, and carpay payment function. Accordingly, the vehicle may maintain its security and prevent illegitimate access by revoking terminated authentication information or authority.

When the task of revoking every authority and deleting biometric information is completed through the above-described process, the deletion mode is completed (509). That is, the vehicle may be in the perfect initial state. Biometric information of the vehicle may be deleted, and the authority of a digital key or a CCS account may be revoked. The vehicle may be ready to start the authentication process again in order to register new biometric information. The completion of the deletion mode (509) may be performed when vehicle sharing is terminated, user authority expires, or a vehicle owner or a user other than the vehicle owner wants to revoke authority from the vehicle and to delete authentication information.

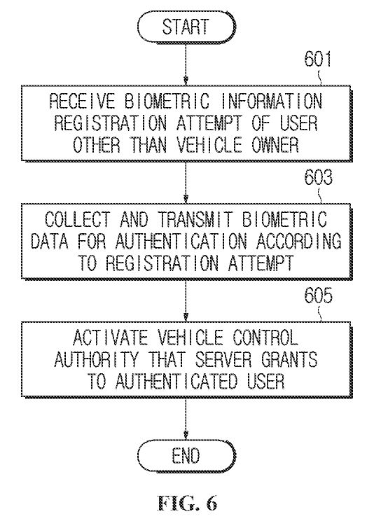

FIG. 6 is a flowchart showing an operating mechanism of an in-vehicle device for registering a user and granting vehicle control authority in connection with a server according to an example of the present disclosure. For convenience, FIG. 6 is described by way of an example in which a processor circuit performs the steps. One, some, or all steps of the example method of FIG. 6, or portions thereof, may be performed by one or more other circuits. One or more steps of the example method of FIG. 6 may be omitted, performed in other orders, and/or otherwise modified, and/or one or more additional steps may be added.

Referring to FIG. 6, a method for granting vehicle control authority through biometric information registration in connection with a server according to the present disclosure may include receiving a biometric information registration attempt (e.g., request) of a user other than a vehicle owner (601), collecting (e.g., receiving) and transmitting biometric data for authentication according to the registration attempt (603), and activating vehicle control authority that the server grants to an authenticated user (605). The steps of FIG. 6 may be performed by an in-vehicle biometric authentication module or application present in the vehicle.

First, according to step S601 above, the receiving of the biometric information registration attempt (e.g., request) of the user, other than the vehicle owner, may be performed as a CCS (e.g., the vehicle management server 101, the digital key server, or any other server) perceives the biometric information registration attempt of the user and forwards the attempt to a vehicle system. If it is the first access to the vehicle or ignition is attempted using a digital key, the CCS may inform the vehicle system of the fact that the user is attempting to register new biometric information. On the other hand, if the user has an existing history of use and reuses biometric information that is already stored, that is, if there is information in the vehicle system, the vehicle itself may make a determination (e.g., user is already registered, new registration is not needed, etc.).

Next, according to step S603 above, the collecting and transmitting of the biometric data for the authentication according to the registration attempt may be performed as the user or the vehicle transmits the data to the server, such that an authentication procedure may be performed. After the registration attempt is performed, an in-vehicle biometric authentication module may be activated to collect biometric data. Herein, the in-vehicle biometric authentication module may collect the user’s biometric information. Herein, the user’s biometric information may include a fingerprint, a face, an iris scan, and/or other biometric information. The vehicle may transmit this data to the CCS. Authentication data collected by the biometric authentication module of the vehicle may be transmitted to be processed by the server. For example, when a fingerprint sensor installed in the vehicle recognizes the user’s fingerprint and transmits the information about the recognition to the CCS, the CCS may perform the authentication procedure by using the information. That is, through real-time communication with the server, the vehicle may ensure that authentication data can be accurately delivered to the server. Thus, the server may perform the authentication procedure for the user.

According to step S605, the activating of the vehicle control authority that the server grants to the authenticated user may execute the vehicle control authority that the CCS grants to the completely authenticated user. The CCS may complete the authentication procedure based on the biometric information provided by the user and grant the vehicle authority to the user. The vehicle control authority may include vehicle unlocking, ignition operation, drive mode activation, and payment authority. The server may send a vehicle control authority-enabled signal to the vehicle, and the vehicle receiving this signal may activate a vehicle control function to enable the user to control the vehicle. The server may also manage a control authority grant record and maintain and manage access authority for an authenticated user.

According to the present disclosure, a method is provided for registering a user and granting vehicle control authority in a server connected with a vehicle. The method may comprise identifying an attempt of biometric information registration of a user other than a vehicle owner, permitting a user holding a plurality of authenticators among multiple authenticators authority for the biometric information registration, and granting the vehicle control authority to a user who completely registers biometric authentication through an in-vehicle biometric authentication module.

According to an example of the method of the present disclosure, the permitting of the authority for the biometric information registration for the user holding the plurality of authenticators among the multiple authenticators may further comprise determining whether a condition for the registration permission is satisfied, and wherein the registered biometric information includes a fingerprint or a face.

According to an example of the method of the present disclosure, the determining of whether the condition for the registration permission is satisfied may comprise determining whether at least one condition is satisfied among a condition regarding whether there are multiple indoor FOBs, a condition regarding whether there is an authenticated digital key or server account, or a condition regarding whether there are multiple authenticators.

According to an example of the method of the present disclosure, the condition regarding whether there are multiple indoor FOBs is determined to be satisfied based on the presence of multiple FOBs that are capable of being registered in a moving object . The FOBs may be searched via at least one system of LF, BLE and UWB of the vehicle.

According to an example of the method of the present disclosure, the condition regarding whether there is an authenticated digital key or server account is determined to be satisfied when the account is confirmed to be valid and the user has authority in starting up or accessing a moving object when the digital key or server account is authenticated.

According to an example of the method of the present disclosure, the condition regarding whether there are multiple authenticators is determined to be satisfied when at least two of an FOB, a digital key, a server account, or an NFC card key are identified as authenticators.

According to an example of the method of the present disclosure, when at least one of the conditions for determining whether the registration is to be permitted is satisfied, the biometric information of the user is normally registered. The user who successfully registers the biometric information may use a vehicle function based on biometric authentication within a preset validity period.

According to an example of the method of the present disclosure, the vehicle control authority granted to the user who successfully registers the biometric authentication includes a function for vehicle entry via biometric authentication, an ignition function, or payment authority via a carpay account, and wherein the authority capable of controlling the vehicle is maintained only for the preset validity period.

According to an example of the method of the present disclosure, the payment authority via the carpay account comprises determining whether the biometric information of a user accessing the payment authority is registered, adding a carpay account connected with the vehicle control authority to the vehicle, and determining whether the biometric information and the carpay account are authenticated. The payment authority may be set to correspond to a sharing period of the vehicle control authority.

According to another example of the present disclosure, a device is provided that grants vehicle control authority through biometric information registration. The device may comprising in a server for registering a user and granting vehicle control authority by being connected with a vehicle, a memory configured to store at least one module, authentication data and control authority and a processor coupled with the vehicle and configured to register biometric information and share the vehicle control authority, wherein the processor is further configured to identify an attempt of biometric information registration of a user other than a vehicle owner, permit a user holding a plurality of authenticators among multiple authenticators authority for the biometric information registration, and grant the vehicle control authority to a user who completely registers biometric authentication through an in-vehicle biometric authentication module.

According to an example of the device of the present disclosure, the processor may be further configured to determine whether a condition for the registration permission is satisfied, when permitting the user holding the plurality of authenticators among the multiple authenticators the authority for the biometric information registration. The registered biometric information may include a fingerprint or a face.

According to an example of the device of the present disclosure, the processor may be further configured to determine whether at least one condition is satisfied among a condition regarding whether there are multiple indoor FOBs, a condition regarding whether there is an authenticated digital key or server account, or a condition regarding whether there are multiple authenticators, when determining whether the condition for the registration permission is satisfied.

According to an example of the device of the present disclosure, the processor may be further configured to determine that the condition regarding whether there are multiple indoor FOBs is satisfied, based on presence of multiple FOBs that are capable of being registered in a moving object and are searched and stored through at least one system of LF, BLE and UWB of the vehicle, when whether registration is to be permitted is determined.

According to an example of the device of the present disclosure, the processor of the device may be further configured to determine that the condition regarding whether there is the authenticated digital key or server account is satisfied, when the account is confirmed to be valid and have authority in starting up or accessing a moving object, while the digital key or server account is authenticated.

According to an example of the device of the present disclosure, the processor of the device may be further configured to determine that the condition regarding whether there are the multiple authenticators is satisfied, when at least two of an FOB, a digital key, a server account, or an NFC card key are identified as authenticators at entry into a registration mode.

According to an example of the device of the present disclosure, the processor of the device is further configured to normally register the biometric information of the user, when at least one of the conditions for determining whether the registration is to be permitted is satisfied, and wherein the user who normally registers the biometric information uses a vehicle function based on biometric authentication within a preset validity period.

According to an example of the device of the present disclosure, the processor of the device may be further configured to include, in the vehicle control authority granted to the user who completely registers the biometric authentication, a function for vehicle entry via biometric authentication, an ignition function, or payment authority via a carpay account, and wherein the authority capable of controlling the vehicle is maintained only for the preset validity period.

According to an example of the device of the present disclosure, the processor of the device may be further configured to revoke the authority capable of controlling the moving object and initialize the biometric information of the user registered in the moving object, based on the expiry of the preset validity period of the authority capable of controlling the moving object.

According to another example of the present disclosure, a method is provided for registering a user and granting control authority in connection with a server. The method may comprise receiving an attempt at biometric information registration of a user other than a vehicle owner, collecting and transmitting biometric data for authentication according to the attempt of registration, and activating the vehicle control authority that the server grants to the authenticated user.

The effects obtainable from the present disclosure are not limited to the effects mentioned above, and other effects not mentioned herein will be clearly understood by those skilled in the art through the following descriptions.

While the methods of the present disclosure described above are represented as a series of operations for clarity of description, it is not intended to limit the order in which the steps are performed. The steps described above may be performed simultaneously or in a different order, as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination with two or more.

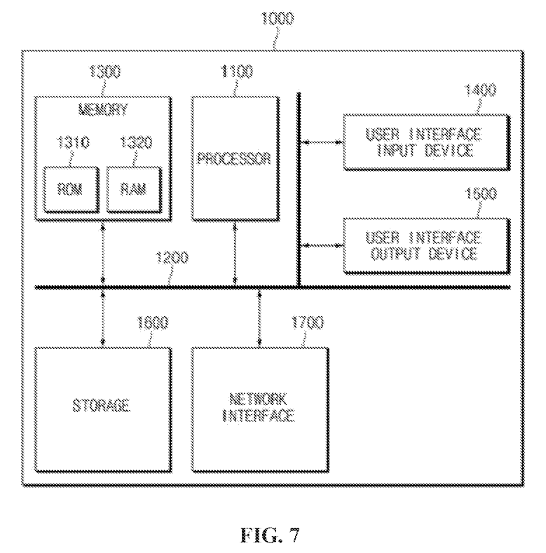

FIG. 7 shows an example computing system (e.g., a computing device of a vehicle, the vehicle management server, the digital key server, and/or other apparatus). One or more controllers, processors, etc., described herein, such as one or more components of the vehicle and any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected via a bus 1200. A user interface may be a device through which a human user can interact with a device. The user interface may include an input interface that can receive an input from the human user and/or an output interface through which data or information can be output to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, etc.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface, and/or an adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link, and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information into the storage medium. Alternatively, the storage medium may be integrated with the processor 1100. The processor and storage medium may be implemented with an application-specific integrated circuit (ASIC). The ASIC may be provided in a user terminal. Alternatively, the processor and storage medium may be implemented with separate components in the user terminal.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method comprising:
receiving, by a server and from an in-vehicle biometric authenticator of a vehicle, a request to register biometric information of a user other than an owner of the vehicle;
receiving, by the server and from the in-vehicle biometric authenticator, first data associated with one or more authenticators associated with the user;
registering, by the server and based on the one or more authenticators, the biometric information of the user; and
sending, by the server and to the in-vehicle biometric authenticator, second data indicating that:
registration of the biometric information of the user is complete; and
the user has been granted vehicle control authority.

2. The method of claim 1, wherein the registering the biometric information of the user comprises determining whether the one or more authenticators satisfy a condition for the registration of the biometric information; and
wherein the registered biometric information includes a fingerprint or a face.

3. The method of claim 2, wherein the determining of whether the one or more authenticators satisfy the condition for registration comprises determining a presence of:
a plurality of indoor frequency operated buttons (FOBs);
an authenticated digital key associated with biometric information registration; or
a plurality of authenticators comprising an authenticated server account or a near field communication (NFC) card key.

4. The method of claim 3, wherein the determining of the presence of the plurality of indoor FOBs comprises determining that the vehicle has detected the presence of the plurality of indoor FOBs inside the vehicle via at least one of , a Bluetooth Low Energy (BLE) signal, or a ultra-wideband (UWB) signal.

5. The method of claim 3, wherein the condition is regarding whether there is the authenticated digital key or the authenticated server account, and wherein the condition is determined to be satisfied based on the server account being confirmed to be valid and having authority in starting up or accessing a vehicle, while the digital key or the server account is authenticated.

6. The method of claim 2, wherein the determining of whether the one or more authenticators satisfy the condition for registration comprises determining whether the user has at least two of:
a first indoor FOB;
a second indoor FOB;
a digital key;
a server account; or
a near field communication (NFC) card key.

7. The method of claim 1, wherein the registration of the biometric information is valid to authorize the user to control at least one vehicle operation of the vehicle for a preset validity period.

8. The method of claim 1, wherein the vehicle control authority granted to the user comprises:
a function for vehicle entry via biometric authentication;
an ignition function; or
payment authority via a carpay account of the user, and
wherein a control authority capable of controlling the vehicle is granted and maintained for a preset validity period based on the granted vehicle control authority.

9. The method of claim 1, wherein the vehicle control authority granted to the user comprises payment authority via a carpay account of the user, the method further comprising:
connecting, based on determining that the biometric information of the user is registered and is associated with the payment authority, the carpay account with the vehicle control authority; and
determining whether the biometric information and the carpay account are authenticated; and
determining that the payment authority is set to correspond to a sharing period of the vehicle control authority.

10. The method of claim 8, further comprising:
based on an expiry of the preset validity period, revoking the control authority capable of controlling the vehicle, and initializing the biometric information of the user registered in the vehicle.

11. A server comprising:
a memory storing at least one instruction; and
a processor configured to execute the at least one instruction, wherein the at least one instruction, when executed by the processor, causes the server to:
receive, via a wireless communication with a vehicle, a request to register biometric information of a user other than an owner of the vehicle;
receive, from an in-vehicle biometric authenticator of a vehicle, first data associated with one or more authenticators associated with the user;
register, based on the one or more authenticators, the biometric information of the user; and
send, to the in-vehicle biometric authenticators, second data indicating that:
registration of the biometric information of the user is complete; and
the user has been granted vehicle control authority.

12. The server of claim 11, wherein the at least one instruction, when executed by the processor, causes the server to register the biometric information of the user by determining whether the one or more authenticators satisfy a condition for the registration of the biometric information; and
wherein the registered biometric information includes a fingerprint or a face.

13. The server of claim 12, wherein the at least one instruction, when executed by the processor, causes the server to determine whether the one or more authenticators satisfy the condition for registration by determining a presence of:
a plurality of indoor frequency operated buttons (FOBs);
an authenticated digital key associated with biometric information registration; or
a plurality of authenticators comprising an authenticated server account or a near field communication (NFC) card key.

14. The server of claim 13, wherein the at least one instruction, when executed by the processor, causes the server to determine the presence of the plurality of indoor FOBs by determining that the vehicle has detected the presence of the plurality of indoor FOBs inside the vehicle via at least one of a Bluetooth Low Energy (BLE) signal or a ultra-wideband (UWB) signal.

15. The device of claim 13, wherein the at least one instruction, when executed by the processor, causes the server to determine that the condition regarding whether there is the authenticated digital key or the authenticated server account is satisfied, based on the server account being confirmed to be valid and having authority in starting up or accessing a vehicle, while the digital key or the server account is authenticated.

16. The server of claim 12, wherein the at least one instruction, when executed by the processor, causes the server to determine whether the one or more authenticators satisfy the condition for registration by determining whether the user has at least two of:
a first indoor FOB;
a second indoor FOB;
a digital key;
a server account; or
a near field communication (NFC) card key.

17. The server of claim 11, wherein the registration of the biometric information is valid to authorize the user to control at least one vehicle operation of the vehicle for a preset validity period.

18. The server of claim 11, wherein the vehicle control authority granted to the user comprises:
a function for vehicle entry via biometric authentication;
an ignition function; or
payment authority via a carpay account of the user, and
wherein a control authority capable of controlling the vehicle is granted and maintained for a preset validity period based on the granted vehicle control authority.

19. The server of claim 11, wherein the vehicle control authority granted to the user comprises payment authority via a carpay account of the user, and
wherein the at least one instruction, when executed by the processor, cause the server to:
connect, based on determining that the biometric information of the user is registered and is associated with the payment authority, the carpay account with the vehicle control authority; and
determine whether the biometric information and the carpay account are authenticated; and
determine that the payment authority is set to correspond to a sharing period of the vehicle control authority.

20. A method performed by a vehicle, the method comprising:
receiving, by an in-vehicle biometric authenticator of the vehicle, first data associated with:
a request to register biometric information of a user other than an owner of the vehicle; and
one or more authenticators associated with the user;
sending, by the in-vehicle biometric authenticator to a server via a wireless communication, the first data;
receiving, by the in-vehicle biometric authenticator and from the server, second data indicating that:
registration of the biometric information of the user is complete; and
the user has been granted vehicle control authority; and
activating, based on the second data, a control authority capable of controlling the vehicle for a preset validity period.
